(19) United States
(12) Patent Application Publication
(10) Pub. No.: US 2008/0252833 A1
(43) Pub. Date: Oct. 16, 2008

(54) Mirror Device With a Switchable Cholesteric Filter

(75) Inventors: Armanda Cinderella Nieuwkerk, Grashoek (NL); Martinus Hermanus Wilhelmus Maria Van Delden, Eindhoven (NL); Rifat Ata Mustafa Hikmet, Eindhoven (NL); Bente Adriaan Bordes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,533

(22) PCT Filed: Aug. 28, 2006
(86) PCT No.: PCT/IB06/52978

§ 371 Date: Mar. 3, 2008

(30) Foreign Application Priority Data
Sep. 5, 2005 (EP) 05108108.1

(51) Int. Cl. G02F 1/1335

(52) U.S. Cl. 349/115

(57) ABSTRACT

The present invention relates to a mirror device, the reflectivity of which may be varied by means of applying a voltage. According to an aspect of the invention, there is provided a mirror device, the reflectivity of which may be varied by means of applying a voltage, comprising a cholesteric filter (33) which is arranged to be gradually switchable between a reflective and a transparent state by varying said voltage, and a display device (32) arranged to be at least partly covered by the cholesteric filter, wherein said display device is visible when the cholesteric filter is set in the transparent state and hidden when the cholesteric filter is set in the reflective state.

The present invention relates to a mirror device, the reflectivity of which may be varied by means of applying a voltage.

For safety reasons, car mirror manufacturers are developing and producing rear view mirrors that may be dimmed. Additionally, they are providing added functionality, such as arranging displays behind rear view mirrors to provide navigation systems.

For the dimming functionality, electrochromic mirror devices are used, allowing the mirror to darken upon upcoming headlights. For displaying information, liquid crystal displays (LCDs) are typically provided in the mirror. In the on-state of the display, a mirror with a display is seen, whereas in the off-state of the display a black hole appears in the mirror at the location where the LCD is arranged. Thus, when the display is off it is not possible to use the complete mirror for viewing.

US 2004/0160657 discloses an electrochromic rear view mirror assembly for a vehicle comprising an electrochromic mirror having a variable reflectivity, a glare sensor for sensing levels of light directed towards the front element from the rear of the vehicle, an ambient sensor for sensing levels of ambient light, a display positioned behind a partially transmissive, partially reflective portion of a reflector for displaying information, and a control circuit coupled to the sensors and the display. The glare sensor is arranged to control a contrast ratio of light originating from the display and light reflecting from the partially transmissive, partially reflective portion of the reflector. A problem with this electrochromic rear view mirror is that the entire mirror area cannot be used for viewing objects when the display is in its off-state, since the partially transmissive and partially reflective portion presents a darkened area with less reflectivity.

An object of the present invention is to alleviate the problems of prior art.

This object is met by a device as set forth in the appended independent claim 1.

According to an aspect of the invention, there is provided a mirror device, the reflectivity of which may be varied by means of applying a voltage, comprising a cholesteric filter which is arranged to be gradually switchable between a reflective and a transparent state by varying said voltage, and a display device arranged to be at least partly covered by the cholesteric filter, wherein said display device is visible when the cholesteric filter is set in the transparent state and hidden when the cholesteric filter is set in the reflective state.

A fundamental principle of the present invention is to take advantage of the properties of a switchable cholesteric filter when providing a mirror device that may be dimmed. The cholesteric filter used in this invention can be switched between a transparent and reflective state with a gradual change in reflectivity. This is an ideal component for use in a rear view car mirror, where dimming of the mirror to reduce glares from headlights increases the safety. The transition from reflective to transparent is controlled by means of applying a voltage to the filter, where a higher voltage implies the transparent state and a lower or no voltage implies the reflective state. For car applications it is mandatory to have a power off mirror state, which is provided by this cholesteric filter. A display device arranged behind the cholesteric filter can now advantageously be completely hidden behind the cholesteric filter, when the filter is set in the reflective state. By way of example, the display device may comprise an LCD, organic LED or an electrophoretic display. Additionally, the reflectivity of a portion of the cholesteric filter which is arranged in front of the display device is equal in reflectivity as compared to other portions of the cholesteric filter. This is particularly useful when the display is in its off-state, and there is no reason to show the display. This offers a great advantage as compared to known car mirrors with displays arranged in the mirror, which presents a “black hole” in place of the display when the display is set in the off-state. When there is information to display, the cholesteric filter of the present invention is set in the transparent mode, whereby the display is visible and, hence, information is available to a passenger of the vehicle (a driver, or possibly a fellow passenger). When the cholesteric filter is set in an intermediate mode, i.e. a mode in between the two extreme modes reflective/transparent, the reflectivity of the mirror is decreased such that objects in the mirror are dimmed. This has the effect of reducing the intensity of reflected light, direct sunbeams, headlights or any other kind of floodlights.

In a first embodiment of the invention, the cholesteric filter is arranged such that at least one portion of the filter can be set in the reflective state while at least another portion can be set in the transparent state. This is advantageous, since separate portions of the filter can be individually set to a reflective, transparent or any intermediate state. Hence, “mirror functionality” of the portions of the mirror device that are not set in the transparent state for making the display visible is maintained.

In a second embodiment, there is provided a mirror device, wherein said mirror is a rear view mirror for an automotive vehicle. Moreover, it is understood that the present invention is suitable for wing mirrors, bathroom mirrors, LCD television sets with mirror functionality, show windows, etc.

In another embodiment of the invention, a mirror device is provided in which the display device is displaying information of a car navigation system. Additionally, information received via car radio, speed of the vehicle, outdoor temperature, etc. can be displayed. The idea of this embodiment is to provide means for displaying useful information to a passenger of the vehicle.

Further features of, and advantages with, the present invention will become apparent when studying the appended claims and the following description. Those skilled in the art realize that different features of the present invention can be combined to create embodiments other than those described in the following.

The various aspects of the invention, including its particular features and advantages, will be readily understood from the following detailed description and the accompanying drawings, in which:

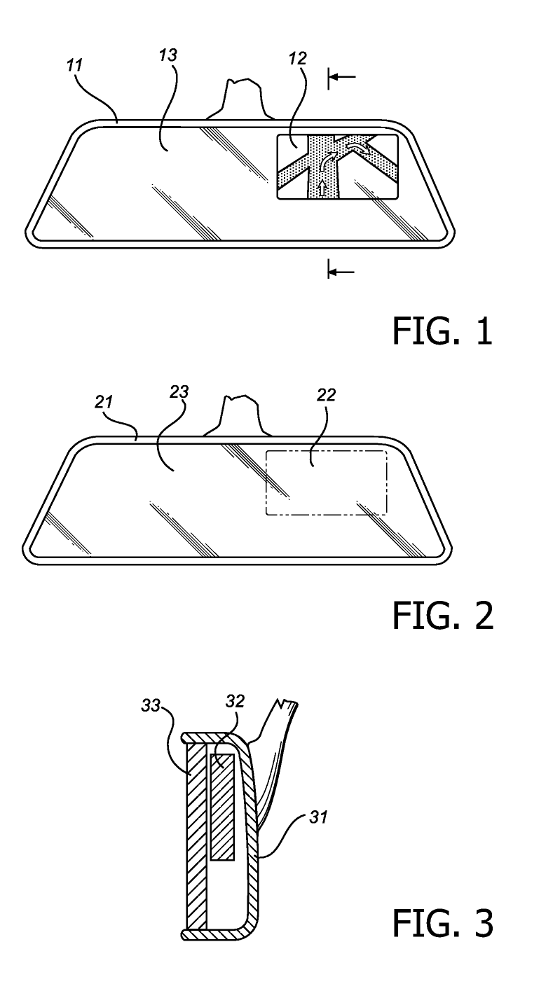

FIG. 1 shows a rear view mirror, in a front view, comprising a cholesteric filter set in the transparent state such that the display arranged behind the cholesteric filter is visible, in accordance with the present invention;

FIG. 2 shows a rear view mirror, in a front view, comprising a cholesteric filter set in the reflective state, in accordance with the present invention;

FIG. 3 shows a rear view mirror according to an embodiment of the present invention in a cross-sectional view;

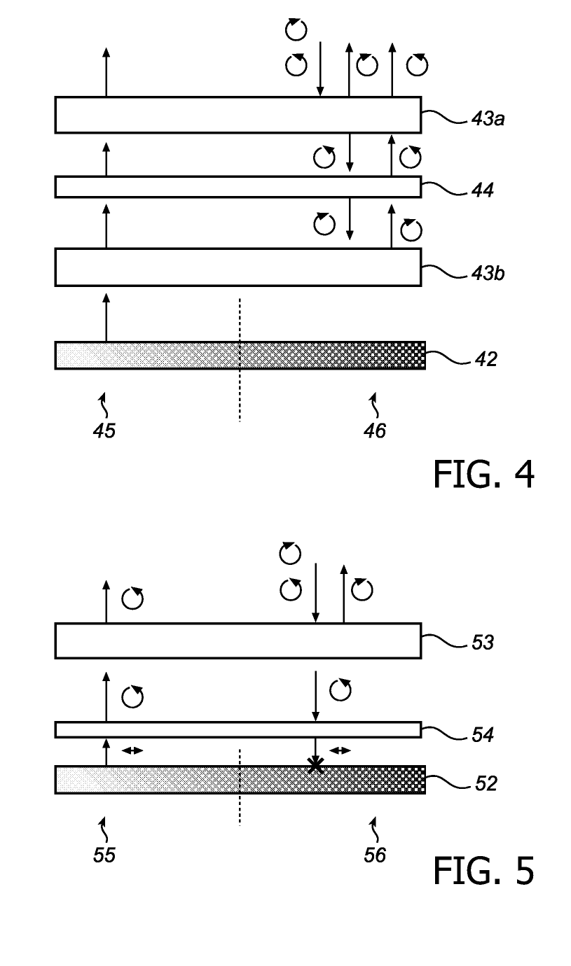

FIG. 4 shows polarization of light in different modes of the mirror device; and

FIG. 5 shows polarization of light in different modes of the mirror device having another configuration.

FIG. 1 shows a rear view mirror comprising a frame 11, a display device 12 and a cholesteric filter 13. The cholesteric filter 13 is set in the transparent state such that the display 12 behind the filter 13 is visible. Only a portion of the cholesteric filter 13 is set in the transparent state, because areas not used by the display 12 is still used for viewing objects behind the vehicle.

In FIG. 2, the cholesteric filter 23 of the rear view mirror in FIG. 1 is set in the reflective state, i.e. a specular surface is provided. Consequently, the display device 22 behind the filter 23 cannot be seen and the entire mirror can be used for viewing objects behind the vehicle.

FIG. 3 shows the rear view mirror according to an embodiment of the invention in a cross-sectional view. The rear view mirror comprises a frame 31 for holding the cholesteric filter 33 and a display device 32. It should be noted that the display device 32 is mounted behind the cholesteric filter 33. In more detail, the cholesteric filter 33 may be of the kind that is described in U.S. Pat. No. 5,798,057 and U.S. Pat. No. 5,762,823, to which reference is made for informative purposes. The switchable cholesteric filter, used in the present invention, comprises two flat, transparent substrates, for example of glass or plastic, which extend parallel to each other and are arranged at some distance from each other. Spacers maintain the appropriate distance between the substrates. The spacers consist of balls or fibers of uniform diameter, which are present between the substrates. Each substrate is provided with a transparent electric electrode, for example of ITO, on the side facing the other substrate. Preferably, the substrates are also provided with an orientation layer, for example of rubbed polyamide or obliquely sputtered SiOx. The cholesteric material is provided between said substrates. For optimal use a quarter wave plate can be inserted between the display (LCD) and cholesteric filter. A cholesteric filter is transmissive for one direction of circular polarized light and reflective for the opposite direction of circular polarized light. An LCD transmits linear polarized light. In order to transmit all light from the display through the cholesteric filter a quarter wave plate is used that can change the linear polarized light into circular polarized light and vice versa. The quarter wave plate is, preferably, be adapted to the properties of both the display and the cholesteric filter. This method is known to a man skilled in the art.

Furthermore, from FIG. 4, it can be seen that in the display mode (45), the switchable mirror devices (43a, 43b) are transparent for the information, being displayed on a general display device (42). The arrows pointing from any display device (42) denote both left- and right-handed circular polarized light, which is transmitted from the display device to and through the switchable mirror device (43a). In the mirror mode (46), 50% of the incoming light is reflected on the first switchable mirror (43a), whereas the left-handed circular polarized light is transmitted. This light is rotated to right-handed polarized light by a half wave plate (44), and reflected from the second switchable mirror (43b). It is then again rotated by the half wave plate (44) into left-handed circular polarized light and transmitted through the first switchable mirror (43a). In total, this gives 100% of reflection (not taking into account losses at interfaces).

In FIG. 5, in the display mode (55), the linear polarized light from the LCD (52) is changed into circular polarized light by the quarter wave plate (54). This circular polarized light is transmitted through the switchable mirror (53). If the switchable mirror (53) is not completely transparent, i.e. the mirror is in the dimming mode, the displayed information is still visible. In the mirror mode (56), the display is off and 50% of the incoming light is reflected (only the right-handed circular polarized light) on the switchable mirror device (53), whereas the left-handed circular polarized light is transmitted. This light is rotated to linear polarized light by the quarter wave plate (54) and the linear polarized light is not reflected by the display device. The light is not reflected by the LCD if it is positioned at an angle with respect to the incoming linear polarized light, such that the incoming linear polarized light will have the opposite orientation compared to the polarizer of the LCD.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A mirror device with a reflectivity varied by applying a voltage, said mirror device comprising:
a cholesteric filter which is arranged to be gradually switchable between a reflective and a transparent state by varying said voltage; and
a display device arranged to be at least partly covered by the cholesteric filter, wherein said display device is visible when the cholesteric filter is set in the transparent state and hidden when the cholesteric filter is set in the reflective state.

2. The mirror device according to claim 1, wherein the cholesteric filter is arranged such that at least one portion of the filter can be set in the reflective state while at least another portion can be set in the transparent state.

3. The mirror device according to claim 1, wherein said mirror device is a rear view mirror of an automotive vehicle.

4. The mirror device according to claim 1, wherein said display device is an LCD.

5. A car navigation system including a mirror device with a reflectivity varied by applying a voltage, said mirror device comprising a cholesteric filter, which is arranged to be gradually switchable between a reflective and a transparent state by varying said voltage, said mirror device further comprising a display device arranged to be at least partly covered by the cholesteric filter, wherein said display device is visible when the cholesteric filter is set in the transparent state and hidden when the cholesteric filter is set in the reflective state.

6. A television set including a mirror device with a reflectivity varied by applying a voltage, said mirror device comprising a cholesteric filter, which is arranged to be gradually switchable between a reflective and a transparent state by varying said voltage, said mirror device further comprising a display device arranged to be at least partly, covered by the cholesteric filter, wherein said display device is visible when the cholesteric filter is set in the transparent state and hidden when the cholesteric filter is set in the reflective state.
